(19) United States
(12) Patent Application Publication
(10) Pub. No.: US 2026/0085822 A1
(43) Pub. Date: Mar. 26, 2026

(54) Glass Integral Lighting

(71) Applicant: Pittsburgh Glass Works, LLC, Cheswick, PA (US)

(72) Inventor: Kyle Fragassi, Pittsburgh, PA (US)

(21) Appl. No.: 19/224,012

(22) Filed: May 30, 2025

Related U.S. Application Data
(60) Provisional application No. 63/654,657, filed on May 31, 2024.

(51) Int. Cl. F21V 19/00; B60J 1/00; B60Q 3/208; F21V 23/00; F21Y 113/00; F21Y 115/10

(52) U.S. Cl. CPC F21V 19/002; F21V 23/001; B60J 1/001; B60Q 3/208; F21Y 2113/00; F21Y 2115/10

(57) ABSTRACT

An article may include at least one pane of glass, at least one interlayer, a plurality of light-emitting diodes (LEDs) disposed within the at least one interlayer, and at least one transparent trace providing power to the plurality of LEDs. The at least one transparent trace may be arranged relative to the at least one interlayer and at least one pane of glass such that the at least one transparent trace is not visible to a user of the article.

### CROSS REFERENCE TO RELATED APPLICATIONS

This application claims priority to U.S. Provisional Ser. No. 63/654,657 , filed May 31, 2024, and titled “Glass Integral Lighting”, the disclosure of which is hereby incorporated by reference in its entirety.

### BACKGROUND OF THE INVENTION

### Field of the Invention

The present disclosure is related to lighting integrated with glass and in particular touch sensitive lighting that is visible to a user.

### Description of Related Art

Lighting is used in homes, offices, motor vehicles, and other transport vehicles in many different ways. One of the ways lighting is used is for ambiance. Used for this purpose, lighting is often arranged in specific fixtures. With more spaces incorporating glass across their ceilings or roofs, especially motor vehicles, it is desirable to integrate lighting into this glass to set a desired ambiance inside a particular space. It is also desirable to have lighting that is sensitive to a user's control so as to achieve a desired effect. Finally, it is desirable to arrange the lighting so that the electrical connections working with the lighting are not visible.

### SUMMARY OF THE INVENTION

An article may include at least one pane of glass, at least one interlayer, a plurality of light-emitting diodes (LEDs) disposed within the at least one interlayer, and at least one transparent trace providing power to the plurality of LEDs and arranged relative to the at least one interlayer and at least one pane of glass such that the at least one transparent trace is not visible to a user of the article.

An article may include a first layer of glass, a first interlayer having a first side and a second side, with the first side of the first interlayer facing the first layer of glass; a film having a first side and a second side, with the first side of the film facing the second side of the first interlayer; a second interlayer having a first side and a second side, with the first side of the second interlayer facing the second side of the film; a second layer of glass having a side facing the second side of the second interlayer; and transparent circuitry arranged on a surface of the first side of the film. The first interlayer may include at least one LED, and the transparent circuitry may be configured to provide power to the at least one LED. A car may include the article.

A method of embedding at least one LED in a substrate may include the steps of arranging the at least one LED on at least one interlayer of the substrate; heating the substrate; and applying pressure to the substrate. Heat and pressure may be applied to the substrate, such that the least one interlayer softens and the least one LED becomes embedded therein. The method may also include the step of electrically connecting the at least one LED to a transparent trace. The transparent trace may be configured to extend over the at least one interlayer.

In some embodiments or aspects, the present disclosure can be described using the following clauses:
Clause 1. An article comprising: at least one pane of glass; at least one interlayer; a plurality of light-emitting diodes (LEDs) disposed within the at least one interlayer; and at least one transparent trace electrically connected to the plurality of LEDs, wherein the at least one transparent trace is arranged relative to the at least one interlayer and at least one pane of glass such that the at least one transparent trace is not visible to a user of the article.
Clause 2. The article of clause 1, wherein the at least one transparent trace is arranged on a surface of the at least one pane of glass or the at least one interlayer.
Clause 3. The article of clause 2, wherein the at least one interlayer comprises: a first interlayer; and a second interlayer, wherein the first interlayer is disposed between the at least one pane of glass and the second interlayer, wherein the at least one transparent trace is disposed on a surface of the second interlayer, and wherein the first interlayer contains the plurality of LEDs disposed therein.
Clause 4. The article of clause 3, wherein the first interlayer is a 0.76 interlayer and the second interlayer comprises polyethylene terephthalate (PET).
Clause 5. The article of clause 4, wherein the at least one interlayer further comprises a third interlayer arranged on a side of the second interlayer opposite the first interlayer, and wherein the third interlayer is a 0.38 interlayer.
Clause 6. The article of any of clauses 3-5 further comprising a conductive coating applied to the surface of the second interlayer, wherein the conductive coating is configured to at least partially define the at least one transparent trace.
Clause 7. The article of clause 6, wherein the conductive coating defines a plurality of deletion lines, wherein the plurality of deletion lines are configured to define the at least one transparent trace, and wherein the plurality of LEDs are arranged along the at least one transparent trace.
Clause 8. The article of clause 7, wherein the conductive coating defines a plurality of intersecting lines, wherein the plurality of intersecting lines extend across the at least one transparent trace between adjacent deletion lines, and wherein each of the plurality of LEDs are arranged over one of the plurality of intersecting lines, such that a first end of an LED is electrically connected to the at least one transparent trace on a first side of an intersecting line and a second end of the LED is electrically connected to the at least one transparent trace on a second side of the intersecting line
Clause 9. The article of any of clauses 1-8 further comprising at least one opaque trace extending about at least a portion of a perimeter of the at least one transparent trace, wherein the at least one opaque trace is configured to provide power to the plurality of LEDs via the at least one transparent trace.
Clause 10. The article of clause 9, wherein the at least one opaque trace comprises silver.
Clause 11. The article of any of clauses 2-8, wherein the at least one pane of glass comprises: a first pane of glass; and a second pane of glass, wherein the at least one interlayer is disposed between the first pane of glass and the second pane of glass.
Clause 12. The article of clause 11 further comprising a conductive coating applied to the surface of the second pane of glass, wherein the conductive coating is configured to at least partially define the at least one transparent trace.
Clause 13. The article of any of clauses 1-12, wherein the at least one pane of glass comprises: a first pane of glass arranged on a first side of the at least one interlayer; and a second pane of glass arranged on a second side of the at least one interlayer, opposite the first side, wherein the plurality of LEDs are visible through at least the first pane of glass.
Clause 14. The article of clause 13, wherein the plurality of LEDs are bonded to the second pane of glass.
Clause 15. The article of clause 13 or 14, wherein the first pane of glass and the second pane of glass are privacy glass or clear glass.
Clause 16. The article of any of clauses 13-15, wherein the first pane of glass is touch sensitive, and wherein the plurality of LEDs are configured such that, by touching the first pane of glass, at least one characteristic of at least a portion of the LEDs changes.
Clause 17. The article of clause 16, wherein the plurality of LEDs are configured such that, by touching the first pane of glass, the at least one characteristic of a portion of the LEDs proximate to the touching changes.
Clause 18. The article of clause 16 or 17, wherein the at least one characteristic comprises brightness, color, and whether the LEDs are on or off.
Clause 19. An article comprising: a first layer of glass; a first interlayer having a first side and a second side, the first side of the first interlayer facing the first layer of glass; a film having a first side and a second side, the first side of the film facing the second side of the first interlayer; a second interlayer having a first side and a second side, the first side of the second interlayer facing the second side of the film; a second layer of glass having a side facing the second side of the second interlayer; and transparent circuitry arranged on a surface of the first side of the film, wherein the first interlayer comprises at least one LED, and wherein the transparent circuitry is configured to provide power to the at least one LED.
Clause 20. The article of clause 19, wherein the first layer of glass is touch sensitive, and wherein the at least one LED is configured such that, by touching the first layer of glass, at least one characteristic of the least one LED changes.
Clause 21. The article of clause 20, wherein the at least one LED comprises a plurality of LEDs, and wherein the plurality of LEDs are configured such that, upon touching the first layer of glass, the at least one characteristic of a portion of the plurality of LEDs proximate to the touching changes.
Clause 22. The article of any of clauses 19-21, wherein the first interlayer is a 0.6 interlayer, wherein the film comprises PET, and wherein the second interlayer is a 0.38 interlayer.
Clause 23. The article of any of clauses 19-22, wherein the first layer of glass and the second layer of glass are privacy glass or clear glass.
Clause 24. The article of any of clauses 19-23 further comprising opaque circuitry extending about at least a portion of a perimeter of the transparent circuitry, wherein the opaque circuitry provides power to the at least one LED via the transparent circuitry.
Clause 25. A car comprising the article of any of clauses 19-24.
Clause 26. A method of embedding at least one LED in a substrate, the method comprising the steps of: arranging the at least one LED on at least one interlayer of the substrate; heating the substrate; and applying pressure to the substrate, wherein heat and pressure are applied to the substrate, such that the at least one interlayer softens and the least one LED becomes embedded therein.
Clause 27. The method of clause 26 further comprising the step of: electrically connecting the at least one LED to a transparent trace, wherein the transparent trace is configured to extend over the at least one interlayer.
Clause 28. The method of clause 27, wherein the substrate comprises: a first pane of glass; the at least one interlayer disposed on a side of the first pane of glass; and a second pane of glass disposed on a side of the at least one interlayer opposite the first pane of glass, wherein the transparent trace is disposed on a surface of the at least one interlayer or the second pane of glass.
Clause 29. The method of claim 28, wherein the at least one interlayer comprises a first interlayer and a second interlayer, wherein the first interlayer is disposed between the first pane of glass and the second interlayer, wherein the second interlayer is disposed between the first interlayer and the second pane of glass, wherein the at least one LED becomes embedded in the first interlayer, and wherein the transparent trace is disposed on a surface of the second interlayer.
Clause 30. The method of clause 29 further comprising the steps of: arranging the at least one LED on the second interlayer; and arranging the at least one LED and the second interlayer on the first interlayer, wherein the heat and pressure are applied to the substrate, such that the first interlayer softens and the least one LED becomes embedded therein.
Clause 31. The method of clause 29 or 30, wherein the at least one interlayer comprises a third interlayer disposed between the second interlayer rand the second pane of glass.
Clause 32. The method of clause 31, wherein the first interlayer is a 0.76 interlayer, wherein the second interlayer comprises PET, and wherein the third interlayer is a 0.38 interlayer.
Clause 33. The method of any of clauses 26-31, wherein the at least one LED comprises a plurality of LEDs.

### BRIEF DESCRIPTION OF THE DRAWING(S)

FIG. 1 is a perspective view of glass integral lighting according to one embodiment or aspect of the present disclosure;

FIG. 2 is a cross-sectional view of the glass integral lighting of FIG. 1 taken along line II-II;

FIG. 3 is an exploded view of the glass integral lighting of FIG. 1;

FIG. 4 is a perspective view of a portion of the glass integral lighting of FIG. 3 identified by circle IV-IV;

FIG. 5 is a cross-sectional view of glass integral lighting according to another embodiment or aspect of the present disclosure;

FIG. 6 is an exploded view of the glass integral lighting of FIG. 5;

FIG. 7 is a cross-sectional view of glass integral lighting according to another embodiment or aspect of the present disclosure;

FIG. 8 is a cross-sectional view of glass integral lighting according to another embodiment or aspect of the present disclosure;

FIG. 9 is a perspective view of a car having glass integral lighting according to one exemplary embodiment or aspect of the present disclosure;

FIG. 10 is a partially transparent, top perspective view of the car and glass integral lighting of FIG. 9;

FIG. 11 is an exploded view of the glass integral lighting used in the car of FIG. 9; and

FIG. 12 is a perspective view of a portion of the glass integral lighting of FIG. 11 identified by circle XII-XII.

### DESCRIPTION OF THE INVENTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the disclosure as shown in the drawing figures and are not to be considered as limiting as the disclosure can assume various alternative orientations.

All numbers and ranges used in the specification and claims are to be understood as being modified in all instances by the term “about”. By “about” is meant plus or minus twenty-five percent of the stated value. However, this should not be considered as limiting to any analysis of the values under the doctrine of equivalents.

Unless otherwise indicated, all ranges disclosed herein are to be understood to encompass the beginning and ending values and any and all subranges subsumed therein. For example, a stated range of “1 to 10” should be considered to include any and all subranges between (and inclusive of) the minimum value of 1 and the maximum value of 10; that is, all subranges or beginning with a minimum value of 1 or more and ending with a maximum value of 10 or less. The ranges disclosed herein represent the average values over the specified range.

The terms “first”, “second”, and the like are not intended to refer to any particular order or chronology, but refer to different conditions, properties, or elements.

The term “at least”is synonymous with “greater than or equal to”.

The term “includes”is synonymous with “comprises”.

The present disclosure is directed to an article that has LEDs that are integral to or embedded within that article to provide lighting from within. One having skill in the art will understand that the articles and LEDs discussed herein can have a number of applications and are not just limited to those examples provided below.

In one example or embodiment, the article may be a substrate, such as glass or a transparent plastic. The glass can be clear glass, so that most or all of the light from the integral LEDs can shine through the glass. In other examples, the glass can be translucent so that only part of the light from the LEDs can shine through. An example of this is GL20 or privacy glass. Other examples of glass can be used, such as a composition known as filtraplus 3 (“FP3”) and a cold formed lamination with a chemically tempered inner portion. In other examples, such as those described below, multiple types of glass can be used in one article, with one pane of one type of glass facing in one direction and another pane of a different type of glass facing an opposing direction. One or both of these panes of glass may contain the integral LEDs. In some cases, plastics can be used. In some examples, the glass or plastic can be heated, so that it softens or melts to a degree to allow the LEDs to be placed into the glass or plastic. When the glass or plastic cools, the LEDs will then be integral with or embedded within the plastic or glass.

Interlayers are also used in connection with LEDs that are integral with articles, such as the glass described above. Examples of interlayers are polyethylene terephthalate (PET), polyvinyl butyral (PVB), polyurethanes, and ethylene vinyl acetate. These interlayers may be applied to the glass or other substrates as film and may have desired thicknesses. In some embodiments, the thickness can range from 0.38-0.80 mm (0.015-0.031 in). Other thicknesses can be used if desired.

To embed the LED into the article, in one example, the LED can be positioned onto a PET film and heated, so that the PET film will soften, allowing the LED to be embedded into the PET film. The PET film and LED can then be applied to the article, like the glass above, to make the LED integral with the article. The softening of the PET does not impact the electrical performance of the LED or the article more generally. In another example, the LED can be positioned onto the PET film, and then the PET film and LED combination can be applied to an interlayer of the article that has been heated to soften the interlayer. This allows the LED to be embedded within the interlayer after it has cooled and hardened. In this example, the interlayer may be a PVB interlayer.

In yet another example, the LED can be positioned onto a PET film, and then the PET film and LED combination can be applied to the article. Heat and pressure can then be applied to the entire article to embed the LED within the interlayer. The heat and pressure applied to the article may result in the LED becoming embedded into the PET film, an interlayer, or the glass, depending on the arrangement of these elements and how the heat and pressure are applied to the article. The application of heat and pressure can be controlled to determine where in the article the LED becomes embedded. In one example, the entire article may be heated and placed under pressure, so that the LED becomes embedded in a PVB interlayer. In this example, the heat and pressure are applied so that the PVB interlayer softens to allow for the LED to become embedded within it. The PVB interlayer may soften before the PET film, or the PET may not soften at all during this process. In another example, heat and pressure may be applied to the article, so that the PET film softens to allow for the LED to become embedded within it. The PET film may soften before the PVB interlayer, or the PVB interlayer may not soften at all during this process. In other examples, the PET film or PVB interlay may be omitted from the article, and the LED can be positioned onto another interlayer or onto the glass. Heating and pressure may be applied to this article in the same manner as previously described to result in the LED being embedded within the other interlayer or the glass.

A variety of LEDs can be used in the system. Examples of LEDs are certified blue LEDs and LEDs having phosphor coatings. The LEDs may be 0.5-0.16 mm (0.002-0.006 in) in height. These LEDs can have different functions, such as changing brightness, changing color, and blinking or flashing. Other functionalities may also be considered.

Traces can be used to provide power to the LEDs when they are embedded in the interlayer and/or substrate. Transparent traces can be directly connected to the LEDs when they are embedded within the interlayer or substrate. They can be laid over top of the LEDs or connected to a side. The transparent traces can also be applied to a surface of one of the layers of the substrate, such as a surface of glass or a surface of a PET film. In this manner, the transparent traces are a printed circuit board (PCB) for the LEDs. This ensures that the transparent traces are not visible through the interlayer(s) or substrate(s). The transparent traces can be made of electrically conductive materials, with process used to sever conductivity in specific areas to enable the formation of traces with specific shapes. Transparent traces may also be made of a bulk conductive material and an opaque mesh having a conductive clear coating that fills in gaps within the trace where needed. Transparent traces may also be made out of a conductive clear coating applied to a surface of the glass or one of the interlayers. In this example, deletion lines may be formed along the coating to create the traces to direct electricity to the LEDs. The transparent coating can be made of silver and/or other conductive materials. In some examples, the coating may be made of one or more layers of conductive materials or multiple layers of conductive and nonconductive materials. One or more opaque traces can be arranged around the interlayer(s) and/or substrate(s)to provide power to the transparent traces in order to reach the LEDs. The opaque trace(s) can be arranged to provide low resistance power distribution, which allows for a larger current and more efficient power distribution to occur through the traces and into the interlayer(s) and substrate(s). The opaque traces can be made of silver or other electrically conductive materials that can be printed onto a base material. The traces provide a conduit and transmission for electrical power to reach the LEDs, allowing them to transmit light through the interlayers and substrates.

Power can be provided to the traces by a variety of sources. A car battery can be used in instances where the interlayer(s) and substrates(s) are used in motor vehicles. Generators, batteries, or other sources may be used in other applications. Batteries may be used with motor vehicle applications. For architectural applications, wall outlets or other power sources related to a building or other structure may be used. In some instances, a DC converter may be used in connection with an AC wall outlet.

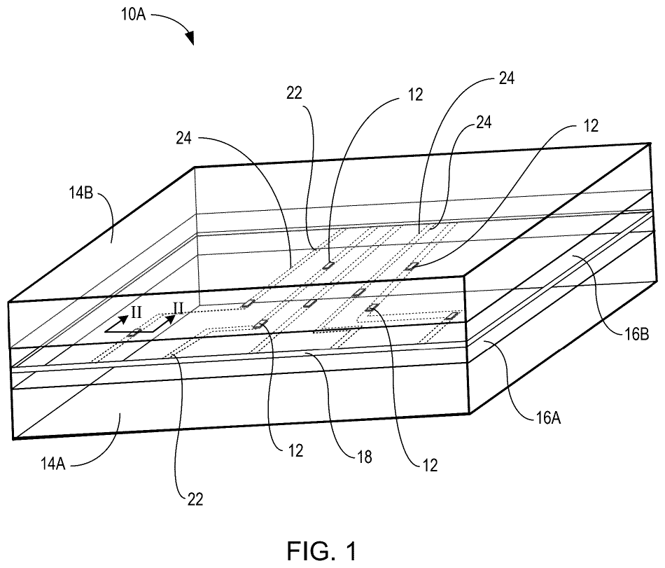

With reference to FIGS. 1-8, examples of integral LED lighting will now be described.

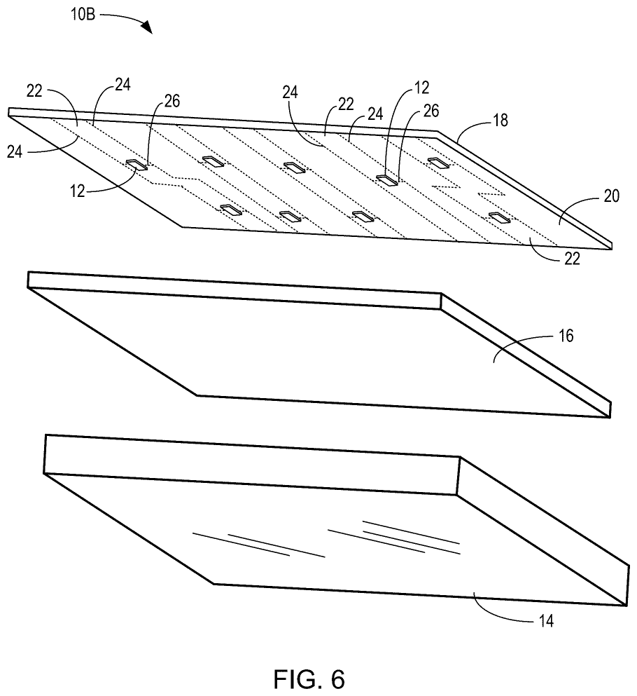

The present disclosure is directed to an article 10A, 10B, 10C, 10D that has LEDs 12 that are integral to the article 10A, 10B, 10C, 10D to provide lighting from within. Generally, the articles 10A, 10B, 10C, 10D may be made of one or more glass layers 14, 14A, 14B one or more interlayers 16, 16A, 16B, a PET film 18, and the LEDs 12. As discussed above, PET is an example of an interlayer. Although the PET film 18 is not explicitly referred to as an interlayer below, the PET film 18 can still considered an interlayer within the articles 10A, 10B, 10C, 10D. Transparent trace(s) 24 may be provided on a surface of the article 10A, 10B, 10C, 10D to provide power to the LEDs. In FIGS. 1 and 6, multiple LEDs 12 are shown within the articles 10A, 10B. However, the number of LEDs 12 shown is not intended to be limiting. Any number of LEDs 12 may be provided within the articles 10A, 10B, 10C, 10D. The LEDs 12 may be arranged in a variety of ways, not just those shown in the figures and discussed below. For clarity, only some LEDs 12 are labeled with reference characters. Also, for clarity, only some of the other features of the articles 10A, 10B, 10C, 10D, such as the traces 24, deletion lines 24, and intersecting lines 26, are labeled with reference characters throughout the drawings.

With reference to FIGS. 1-4, one embodiment of an article 10A is shown. Moving from the bottom of the article 10A to the top, the article 10A includes a first pane of glass 14A, a first interlayer 16A, a PET film 18, a second interlayer 16B, and a second pane of glass 14B. In this arrangement, different surfaces or sides of these features contact each other. A surface of the first pane of glass 14A contacts a surface of the first interlayer 16A. The opposing surface of the first interlayer 16A contacts a surface of the PET film 18. The opposing surface of the PET film 18 contacts a surface of the second interlayer 16B. The opposing surface of the second interlayer 16B contacts a surface of the second pane of glass 14B. The free surfaces or sides of the panes of glass 14A, 14B may be exposed to the environment.

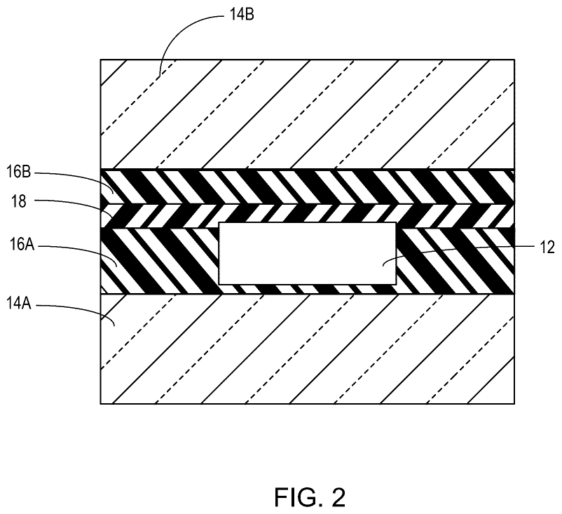

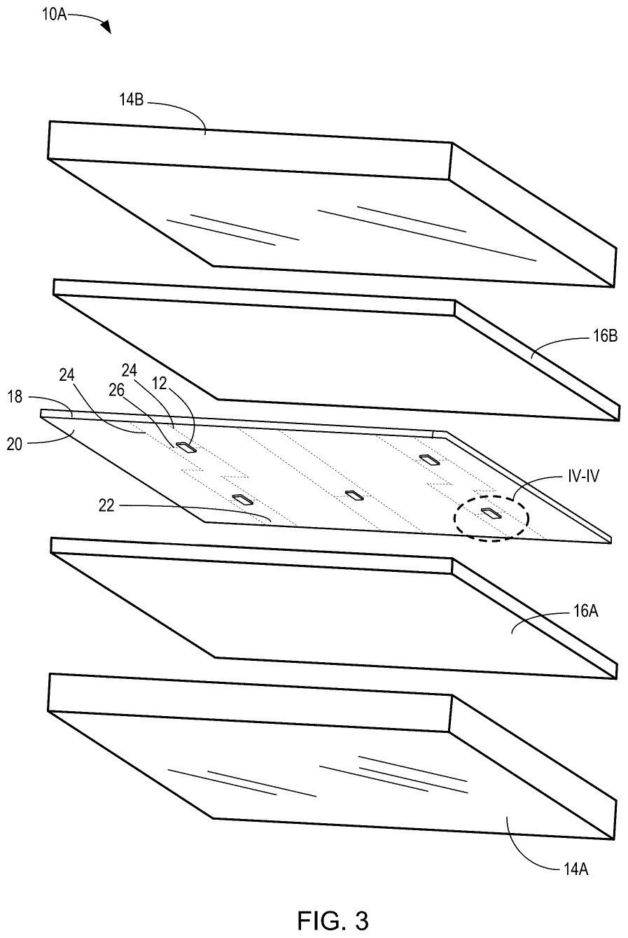

As shown in FIGS. 1 and 2, the LEDs 12 are connected to and extend downward from the PET film 18 and are embedded within the first interlayer 16A. The first interlayer 16A may be a PVB interlayer as discussed above. As shown in FIG. 3, the LEDs 12 are also connected to the PET film 18. As discussed above, the LEDs 12 may be connected to the PET film 18 before the article 10A is assembled. After the article 10A is assembled, heat and pressure may be applied to the article 10A, which results in the LEDs 12 being embedded within the first interlayer 16A.

As shown in FIGS. 1 and 3, the PET film 18 includes a conductive coating 20 applied to the surface facing the first interlayer 16A. The conductive coating 20 is transparent and allows for electricity to travel through the article 10A to power the LEDs. The conductive coating 20 is used to create transparent traces 22 that extend along the surface of the PET film 18. The terms “traces” and “transparent traces” will be used interchangeably in connection with reference character 22. The conductive coating 20 and transparent traces 22 function as a printed circuit board to provide power to the LEDs 12. The LEDs 12 are placed along the traces 22 and are electronically connected to the traces 22 to receive power. The traces 22 may be created by deletion lines 24 formed within the conductive coating 20. The deletion lines 24 are spaces along the surface of the PET film 18 where no conductive coating 20 is present. The deletion lines 24 are arranged to isolate strips of the conductive coating 20, so that these strips can create the traces 22. In this example, the traces 22 may be thought of as a channel extending across the conductive coating 20 and bound by the deletion lines 24. In one example, the deletion lines 24 can be formed after the conductive coating 20 is applied to the PET film 18. In this example, laser ablation, mechanical ablation, mechanical ablation using a heated or burning contact point, or other methods known to those having skill in the art can be used to remove parts of the conductive coating 20 to create the deletion lines 24 and traces 22. In another example, the deletion lines can be formed by masking the PET film 18 before the conductive coating 20 is applied. In this example, a washable printed mask is applied to the PET film 18 in locations where the deletion lines are to be formed, before the conductive coating 20 is applied. Then, the PET film 18 will be washed to remove the printed mask and conductive coating 20 that was applied over the printed mask. After this washing, the deletion lines 24 and traces 22 will remain on the PET film 18.

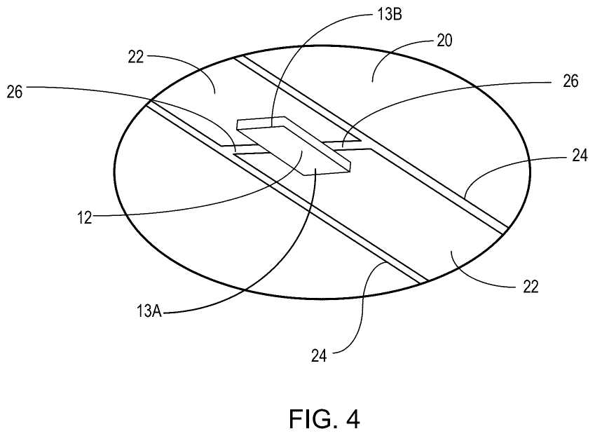

In instances where the traces 22 are formed by deletion lines 24, the traces 22 are provided with intersecting lines 26 to direct power from a trace 22 to an LEDs 12. The intersecting lines 26 extend between adjacent deletion lines 24 that form a trace 22. The intersecting lines 26 are the same as the deletion lines 24 in that the intersecting lines 26 are a space on the surface of the PET film 18 where no conductive coating 20 is present. The intersecting lines 26 create a gap in the trace 22. The LEDs 12 are arranged over the intersecting lines 26, so that a first end 13A of the LED 12 is electrically connected to the trace 22 on a first side of an intersecting line 26 and a second end 13B of the LED 12 is electrically connected to the trace 22 on a second side of the intersecting line 26. This arrangement forces the electricity traveling through a trace 22 to travel through the LED 12. This is shown in FIG. 4. The intersecting lines 26 may be formed in the conductive coating 20 in the same manner as the deletion lines 24.

In another example, the traces 22 may be formed on a surface of the PET film 18 without using the conductive coating. In this example, the traces 22 may be formed directly on the PET film 18, instead of using the conductive coating 20 and forming the traces 22 via deletion lines 24.

With this arrangement of the article 10A, the LEDs 12 can transmit light through the first interlayer 16A and first pane of glass 14A. In some examples, the LEDs 12 may also transmit light through the second interlayer 16B and the second pane of glass 14B. Regardless of how the traces 22 are formed and used within the article 10A, the article 10A allows the light created by the LEDs 12 to be transmitted and visible to a person without any wiring or other circuity being visible. This allows for a more pleasant and aesthetic viewing experience for a person looking at the article 10A.

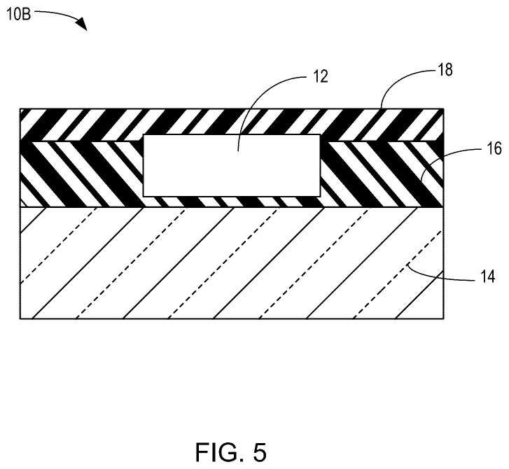

With reference to FIGS. 5 and 6, another embodiment of an article 10B is shown. From top to bottom, the article 10B includes a PET film 18, an interlayer 16, and a pane of glass 14. The LEDs 12 are embedded within the interlayer 16 of the article 10B in the same manner as described above. Power may also be transmitted to the LEDs 12 in the same manner as described above, using a conductive coating 20 on the surface of the PET film 18 facing the interlayer 16 and forming traces 22 via deletion lines 24 and intersecting lines 26. Transparent traces 22 may also be formed by creating the traces 22 directly on the PET film 18.

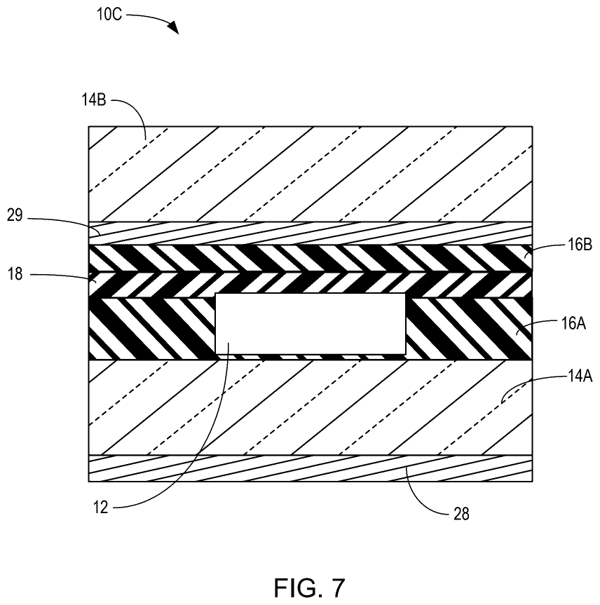

With reference to FIG. 7, another embodiment of an article 10C is shown via cross-sectional view, which is similar to cross-sectional views shown in FIGS. 3 and 5. From bottom to top, the article 10C includes a first coating 28, a first pane of glass 14A, a first interlayer 16A, a PET film 18, a second interlayer 16B, a second coating 29, and a second pane of glass 14B. The LEDs 12 are embedded within the first interlayer 16A of the article 10C in the same manner as described above. Power may also be transmitted to the LEDs 12 in the same manner as described above, using a conductive coating 20 on the surface of the PET film 18 facing the first interlayer 16A and forming traces 22 via deletion lines 24 and intersecting lines 26. Transparent traces 22 may also be formed directly on the PET film 18. The presence of the coatings 28, 29 allows for the article 10C to exhibit certain properties. As shown, the coatings 28, 29 may be metallic. However, other types of coatings may be used to impart certain properties on the article 10C. In one example, the first coating 28 may be a low emissivity thermal performance or antireflective coating. The presence of an antireflective coating 28 may prevent outside light from being reflected by the first pane of glass 14A. This allows the light from the LEDs 12 to be clearly displayed through the first pane of glass 14A. In another example, the second coating 29 may be designed to reflect infrared light. In instances where the article 10C is used as a window in automotive or architectural applications, this will prevent some or all outside infrared light from passing through the article 10C.

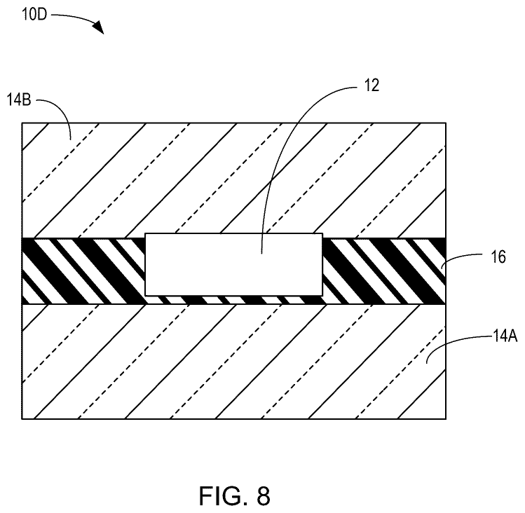

With reference to FIG. 8, a final embodiment of an article 10D is shown via cross-sectional view, which is similar to cross-sectional views shown in FIGS. 3, 5, and 7. From bottom to top, the article 10D includes a first pane of glass 14A, an interlayer 16, and a second pane of glass 14B. The LEDs 12 are embedded within the interlayer 16 of the article 10D in the same manner as described above. Instead of providing a conductive coating 20 and/or traces 22 on a PET film 18 as described in previous examples, the transparent coating 20 and/or traces 22 may be provided on the second pane of glass 14B. While not shown, the transparent coating 20 and/or traces 22 may be provided on the surface of the second pane of glass 14B in the same manner as the transparent coating 20 and/or traces 22 are provided on the PET film 18 in previous examples. In this arrangement, the LEDs 12 are connected or bonded to the second pane of glass 14B along the transparent coating 20 and/or traces 22. As with the previous examples, when deletion lines 24 are used to create the traces 22, the LEDs 12 may be arranged on the second pane of glass 14B over a the intersecting lines 26. With this arrangement, power is provided to the embedded LEDs 12 via this surface of the second pane of glass 14B.

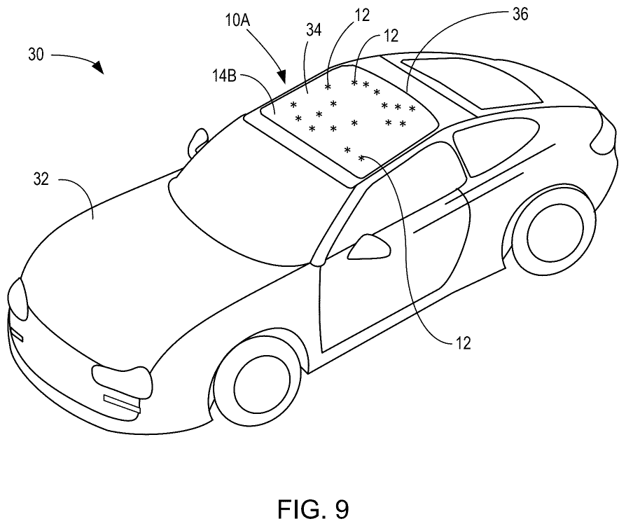

The articles 10A, 10B, 10C, 10D described above have a number of different applications, and can be used on, for example, windows, roofs, and walls. These windows, roofs, and walls may be found in homes, office buildings, classrooms, museums, planetariums, or other structures, including motor vehicles. In some applications, the articles 10A, 10B, 10C, 10D may replace a window, screen, or other structure. In an exemplary embodiment, the articles 10A, 10B, 10C, 10D may be used as a sunroof of a motor vehicle. This will now be shown and described in connection with FIGS. 9-12. Based on this description, one having ordinary skill in the art will appreciate how the article 10 may be used in other applications.

With reference to FIGS. 9-12, the article 10A is used in a motor vehicle 30. While the article 10A is shown and described, one will understand that articles 10B, 10C, 10D may also be used with the vehicle 30. Based on this description, one will also understand how the different articles 10A, 10B, 10C, 10D can be used in other applications outside of a vehicle 30.

The vehicle 30 has a body 32, which includes a sunroof 34 formed within an opening 36 along a top surface thereof. The body 32 defines a space at least partially bound by the opening 36, and the article 10A is shaped to occupy some or all of that space. As shown, the second pane of glass 14B extends across the opening 36. As shown in FIG. 9, a number of LEDs 12 embedded within the article 10A are visible through the first pane of glass 14A. However, it is to be understood that the first pane of glass 14A may be such that the LEDs 12 are not visible through the first pane 14A. In this instance, the article 10A may be arranged, so that the LEDs are only visible through the second pane of glass 14B from the interior of the vehicle 30.

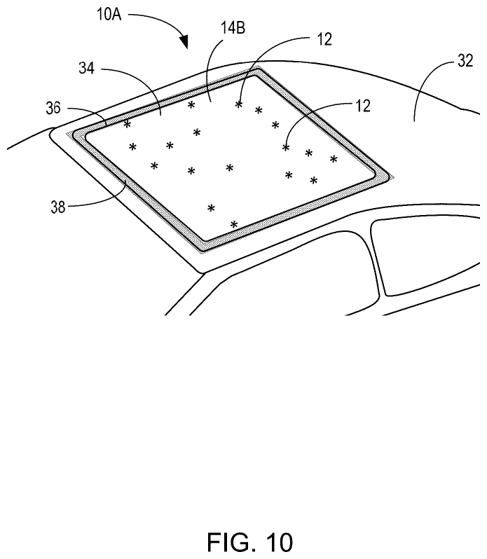

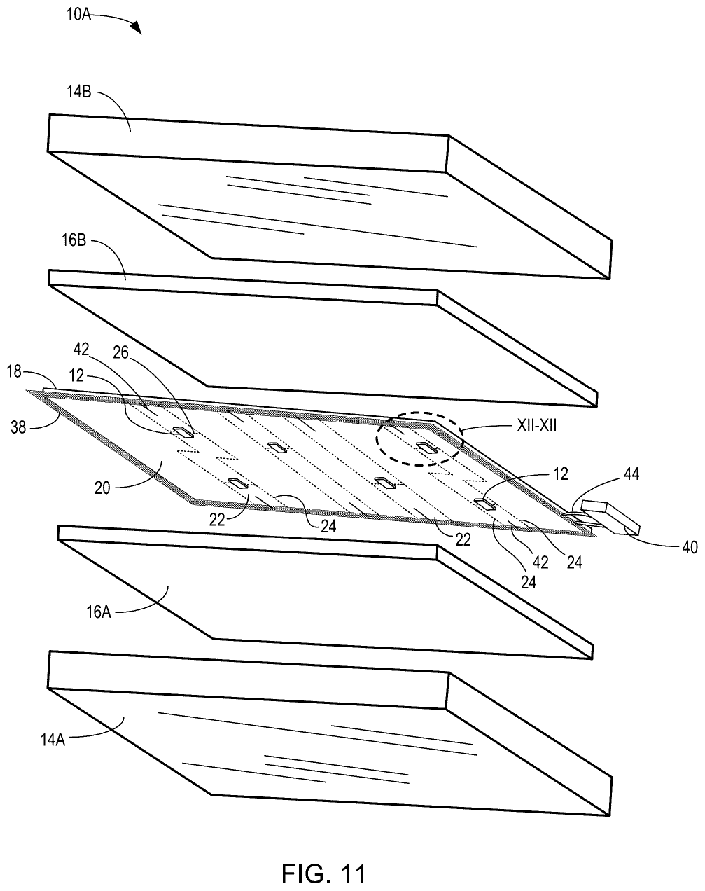

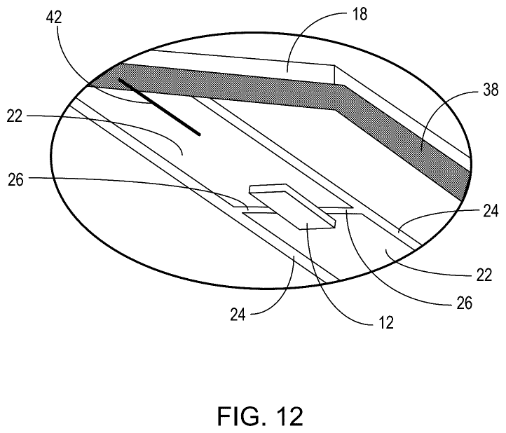

In FIG. 10, the body 32 of the vehicle 30 surrounding the opening 36 is shown as transparent. An opaque trace 38 is arranged within the body 32 around the article 10A. The opaque trace 38 is used to provide power to the LEDs 12 within the article 10A. The opaque trace 38 surrounds at least a portion of the article 10A and is electrically connected to the conductive coating 20 and/or transparent traces 22 arranged on the PET film 18. As shown in FIGS. 10 and 11, the opaque trace 38 extends around an entire perimeter of the article 10A. As shown in FIGS. 11 and 12, the opaque trace 38 is also aligned with the PET film 18. However, the opaque trace 38 may take different shapes and extend around only a portion of the article 10A and/or PET film 18, so long as power is properly transferred to the conductive coating 20 and/or transparent traces 22. For example, the opaque trace 38 may be arranged along only two sides of the article 10A and/or PET film 18, or the opaque trace 38 may be arranged, so that it only covers opposing ends of the transparent traces 22. The opaque trace 38 does not need to be aligned with the PET film 18. For example, the opaque trace 38 may be arranged along some or all of the perimeter(s) of the interlayers 16A, 16B or panes of glass 14A, 14B. In one example, the opaque trace 38 may be arranged against some or all of the exposed side surfaces of the second interlayer 16B and second pane of glass 14B. Different arrangements of the opaque trace 38 may be used, so long as the opaque trace 38 can be electrically connected to the conductive coating 20 and/or transparent traces 22.

As shown in FIGS. 11 and 12, electrical connectors 42 extend from the opaque trace 38 and contact the conductive coating 20 and/or transparent traces 22 at one or more points around the outer edge of the PET film 18 to create the electrical connections. The opaque trace 38 and the electrical connectors 42 may be made of silver epoxy, silver enamel, or other conductive materials to create these connections. At least one electrical connector 42 may be used for each transparent trace 22 formed on the PET film 18. In some instances, two electrical connectors 42 may be used for each transparent trace 22, with one electrical connector 42 being arranged at the ends of each transparent trace 22. In other instances, the number and arrangement of the transparent traces 22 on the PET film 18 may be used to determine the number of electrical connectors uses 42 with the opaque trace 38. In instances where the opaque trace 38 is not aligned with the PET film 18, the electrical connectors 42 may be elongated to create the electrical connection(s) with the transparent traces 22. It is also contemplated that electrical connectors 42 do not need to be used with the article 10A and opaque trace 38. In these instances, there may be some overlap between the opaque trace 38 and the transparent traces 22 to create the electrical connection(s) between these features.

As shown in FIG. 11, the opaque trace 38 is connected to a power source 40, which is the ultimate source of power for the LEDs 12. Cables 44 or other electrical connectors can be used to connect the power source 40 to the opaque trace 38. When the article 10A is used as a sunroof 34, the power source 40 may be the battery or engine of the vehicle 30. In other applications, the power source 40 may be a wall outlet or portable power source. With this arrangement, the LEDs 12 are powered by way of the conductive coating 20 and/or transparent traces 22, opaque trace 38, and power source 40.

Referring back to FIGS. 1 and 2, along with FIGS. 9-12, the components of the article 10A may have certain characteristics to allow for the article 10A to operate as the sunroof 34. For example, the panes of glass 14A, 14B may have different transparency levels. The second pane 14B, which is the pane of glass that is flush with the body 32 of the vehicle 30, can be privacy glass or GL20 glass, so that light cannot escape upwards and into the environment outside of the motor vehicle. This also prevents light from entering the vehicle 30 through the article 10A. Darker or lighter glass may also be used depending on a user's need for privacy. The first pane 14A, which is the pane of glass that faces the interior of the vehicle 30, can be an FP3 or a more transparent type of glass to allow the LEDs 12 to transmit light therethrough. The panes of glass 14A, 14B may have the same or different of thicknesses. For example, as shown, the panes of glass 14A, 14B may have a thickness of 2.1 mm (0.083 in). In other examples, the panes of glass 14A, 14B may have thicknesses ranging from 0.5-3.5 mm (0.020-0.138 in). The first pane of glass 14A may also have a thickness that is different from the second pane of glass 14B. For example, when the article 10A is used with a motor vehicle 30, as shown and described in connection with FIGS. 9-12, the second pane of glass 14B used on the outside of the vehicle 30 may be thicker than the first pane of glass 14A to account for rock chip prevention or other potential damage that may occur due to its placement. The thicknesses of the panes of glass 14A, 14B may be modified depending on how the article 10A will be used. For example, the second pane of glass 14B The interlayers 16A, 16B may have different thicknesses. For example, the first interlayer 16A has a thickness of 0.76 mm (0.030 in), and the second interlayer 16B has a thickness of 0.38 mm (0.015 in). Different interlayer thicknesses may be used, but they will generally range from 0.38-0.80 mm (0.015-0.031 in), with midpoints selected at 0.5 mm (0.012 in), 0.625 mm (0.025 in), 0.76 mm (0.030in). For example, both interlayers 16A, 16B may have a thickness of 0.38 mm (0.015 in). Different gels may be used with the interlayers 16A, 16B, so as to achieve desired acoustics within the glass, thereby muffling or enhancing sound relative to the motor vehicle. The first interlayer 16A is typically thicker than the second interlayer 16B because the LEDs 12 are disposed within the first interlayer 16A, but this need not be the case.

The LEDs 12 may be arranged so as to provide light to people sitting inside the motor vehicle, without being shown outside of the motor vehicle. Different types of glass can be used for the panes 14A, 14B to achieve this effect. The LEDs 12 may be turned on and off with a simple switch or other methods known to those having skill in the art. The first pane 14A may also be touch sensitive so as to turn the LEDs 12 on and off simply by touching the first pane 14A at different locations. In this instance, the first pane 14A may have additional electronics or wiring passing through to control the power directed to the LEDs 12. Such electrical connections may also be transparent, like transparent traces 22. The control of the LEDs 12 may also be localized. In other words, touching one corner of the first pane 14A may control only the LEDs 12 near that corner. The same can happen across the first pane 14A. For example, if a cluster of LEDs 12 are arranged in the article 10A, then touching the first pane 14A at a point approximately central to that cluster of LEDs 12 may control that cluster of LEDs 12. Touching a portion of the first pane 14A with multiple fingers or an entire hand may control the LEDs 12 covered by the fingers and/or hand. Dragging a finger across the first pane 14A may control the LEDs 12 that are proximate to the area covered the dragged finger.

Touching the first pane 14A may also control different features of the LEDs 12 instead of simply turning the LEDs 12 on or off. For example, the color, brightness, flashiness, and different features of the LEDs 12 can be controlled. This control may happen simultaneously, or different controls can be cycled through with different touches of the first pane 14A. Different types of touches may also trigger different actions. For example, holding a touch against the first pane 14A for 3-5 seconds may change the brightness of the LEDs 12, holding a touch against the first pane 14A for 5-7 seconds may change the color, and touching the first pane 14A for more than 7 seconds may trigger the LEDs 12 to twinkle or flash. It is also contemplated that only a portion of the first pane 14A may be touch sensitive. This touch sensitive portion may control the LEDs 12 across the entire article with similar controls.

The LEDs 12 may also form different designs in the glass 14. For example, different constellations can be shown across the panes of glass 14A, 14B. Examples of these constellations, such as the Big Dipper, can be seen in FIGS. 9 and 10. While FIGS. 9 and 10 show the second pane of glass 14B, one will understand that the same or similar designs will be visible through the first pane of glass 14A arranged in the interior of the vehicle 30. Such constellations may match those present outside of the vehicle 30. Linking the vehicle 30 to a GPS may lead to those constellations changing depending on the exact location of the vehicle 30. This GPS linkage can also result in directional arrows being formed in the LEDs 12 to inform passengers of the vehicle 30 the direction(s) in which the car is or will be travelling. In some modes, different designs can be “drawn” in the first pane 14A by dragging a finger across the first pane 14A, triggering different LEDs 12 to turn on and others to turn off according to the action(s) of a user.

As discussed above, the articles 10A, 10B, 10C, 10D are formed by applying heat and pressure to an article 10A, 10B, 10C, 10D or parts of the article in order for the LEDs 12 to become embedded therein. Referring back to FIGS. 1-3, methods of forming article 10A will be described. First, the traces 22 are formed on a surface of the PET film 18 in the manner discussed previously. The LEDs 12 are arranged on the surface of the PET film 18, so that they can be powered by the traces 22. The article 10A is then assembled, with the PET film 18 having the LEDs 12 arranged between the first interlayer 16A and the second interlayer 16B, so that the LEDs 12 face the first interlayer 16A. Heat and pressure are applied to the article 10A, so that the first interlayer 16A softens and receives the LEDs 12 therein. Then, the article 10A is cooled, so that the first interlayer 16A hardens around the LEDs 12, and the LEDs 12 become embedded within the first interlayer 16A. The LEDs 12, conductive coating 20, and traces 22 are such that the heat and pressure applied to the article 10A does not negatively impact or degrade the electrical properties of these elements or the electrical connections between them. While the heat and pressure can be applied to the entirety of article 10A, the article 10A may also be formed after heat and pressure are applied to specific components. For example, heat and pressure may only be applied to the PET film 18 having the LEDs 12 and the first substrate 16A. After the PET film 18, LEDs 12, and first substrate 16A are cooled and the LEDs 12 are embedded within the first substrate 16A, these three elements may be arranged within the article 10A between the first pane of glass 14A and the second interlayer 16B as shown. In another example, heat and pressure may be applied to the first pane of glass 14A, first interlayer 16A, LEDs 12, and PET film 18, in an arrangement similar to what is shown in FIGS. 5 and 6. After these features are cooled, the second interlayer 16B and second pane of glass 14B are applied to form the article 10A. Although the LEDs 12 are shown as being embedded within the first interlayer 16A, it is contemplated that heat and pressure may be applied to the article 10A, so that the PET film 18 softens, instead of the first interlayer 16A. This results in the LEDs 12 becoming embedded in the PET film 18.

Referring back to FIG. 8, article 10D may be formed in a similar manner. First, the traces (not shown in FIG. 8) are formed on a surface of the second pane of glass 14B in the manner discussed previously. The LEDs 12 are arranged on the second pane of glass 14B, so that they can be powered by the traces. The article 10D is assembled, with the LEDs 12 facing the interlayer 16. Heat and pressure are applied to the article 10D, so that the interlayer 16 softens and receives the LEDs 12 therein. Then, the article 10D is cooled, so that the interlayer 16 hardens around the LEDs 12, and the LEDs 12 become embedded in the interlayer 16. Similar to the example discussed above, the entire article 10D does not need to undergo the heating and pressure process. Instead, only the interlayer 16, LEDs 12, and second pane of glass 14B may be heated and pressurized, and the first pane of glass 14A can be applied after cooling.

While specific embodiments of the device of the present disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the device of the present disclosure which is to be given the full breadth of the claims appended and any and all equivalents thereof.

The invention claimed is

1. An article comprising:
at least one pane of glass;
at least one interlayer;
a plurality of light-emitting diodes (LEDs) disposed within the at least one interlayer; and
at least one transparent trace electrically connected to the plurality of LEDs,
wherein the at least one transparent trace is arranged relative to the at least one interlayer and at least one pane of glass such that the at least one transparent trace is not visible to a user of the article.

2. The article of claim 1, wherein the at least one transparent trace is arranged on a surface of the at least one pane of glass or the at least one interlayer.

3. The article of claim 2, wherein the at least one interlayer comprises:
a first interlayer; and
a second interlayer,
wherein the first interlayer is disposed between the at least one pane of glass and the second interlayer,
wherein the at least one transparent trace is disposed on a surface of the second interlayer, and
wherein the first interlayer contains the plurality of LEDs disposed therein.

4. The article of claim 3, wherein the first interlayer is a 0.76 interlayer and the second interlayer comprises polyethylene terephthalate (PET).

5. The article of claim 4, wherein the at least one interlayer further comprises a third interlayer arranged on a side of the second interlayer opposite the first interlayer, and
wherein the third interlayer is a 0.38 interlayer.

6. The article of claim 3 further comprising a conductive coating applied to the surface of the second interlayer,
wherein the conductive coating is configured to at least partially define the at least one transparent trace.

7. The article of claim 6, wherein the conductive coating defines a plurality of deletion lines,
wherein the plurality of deletion lines are configured to define the at least one transparent trace, and
wherein the plurality of LEDs are arranged along the at least one transparent trace.

8. The article of claim 7, wherein the conductive coating defines a plurality of intersecting lines,
wherein the plurality of intersecting lines extend across the at least one transparent trace between adjacent deletion lines, and
wherein each of the plurality of LEDs are arranged over one of the plurality of intersecting lines, such that a first end of an LED is electrically connected to the at least one transparent trace on a first side of an intersecting line and a second end of the LED is electrically connected to the at least one transparent trace on a second side of the intersecting line.

9. The article of claim 1 further comprising at least one opaque trace extending about at least a portion of a perimeter of the at least one transparent trace,
wherein the at least one opaque trace is configured to provide power to the plurality of LEDs via the at least one transparent trace.

10. The article of claim 9, wherein the at least one opaque trace comprises silver.

11. An article comprising:
a first layer of glass;
a first interlayer having a first side and a second side, the first side of the first interlayer facing the first layer of glass;
a film having a first side and a second side, the first side of the film facing the second side of the first interlayer;
a second interlayer having a first side and a second side, the first side of the second interlayer facing the second side of the film;
a second layer of glass having a side facing the second side of the second interlayer; and
transparent circuitry arranged on a surface of the first side of the film,
wherein the first interlayer comprises at least one LED, and
wherein the transparent circuitry is configured to provide power to the at least one LED.

12. The article of claim 11, wherein the first layer of glass is touch sensitive, and
wherein the at least one LED is configured such that, by touching the first layer of glass, at least one characteristic of the at least one LED changes.

13. The article of claim 12, wherein the at least one LED comprises a plurality of LEDs, and
wherein the plurality of LEDs are configured such that, upon touching the first layer of glass, the at least one characteristic of a portion of the plurality of LEDs proximate to the touching changes.

14. The article of claim 11 further comprising opaque circuitry extending about at least a portion of a perimeter of the transparent circuitry,
wherein the opaque circuitry provides power to the at least one LED via the transparent circuitry.

15. A car comprising the article of claim 11.

16. A method of embedding at least one LED in a substrate, the method comprising the steps of:
arranging the at least one LED on at least one interlayer of the substrate;
heating the substrate; and
applying pressure to the substrate,
wherein heat and pressure are applied to the substrate, such that the at least one interlayer softens and the at least one LED becomes embedded therein.

17. The method of claim 16 further comprising the step of:
electrically connecting the at least one LED to a transparent trace,
wherein the transparent trace is configured to extend over the at least one interlayer.

18. The method of claim 17, wherein the substrate comprises:
a first pane of glass;
the at least one interlayer disposed on a side of the first pane of glass; and
a second pane of glass disposed on a side of the at least one interlayer opposite the first pane of glass,
wherein the transparent trace is disposed on a surface of the at least one interlayer or the second pane of glass.

19. The method of claim 18, wherein the at least one interlayer comprises a first interlayer and a second interlayer,
wherein the first interlayer is disposed between the first pane of glass and the second interlayer,
wherein the second interlayer is disposed between the first interlayer and the second pane of glass,
wherein the at least one LED becomes embedded in the first interlayer, and
wherein the transparent trace is disposed on a surface of the second interlayer.

20. The method of claim 19 further comprising the steps of:
arranging the at least one LED on the second interlayer; and
arranging the at least one LED and the second interlayer on the first interlayer,
wherein the heat and pressure are applied to the substrate, such that the first interlayer softens and the at least one LED becomes embedded therein.
